(19) United States
(12) Patent Application Publication
(10) Pub. No.: US 2021/0319197 A1
(43) Pub. Date: Oct. 14, 2021

(54) APPARATUS AND METHOD FOR OPTICALLY CAPTURING FINGERPRINT OR OTHER IMAGES ON DISPLAY SCREEN

(71) Applicant: Bidirectional Display Inc., Acton, MA (US)

(72) Inventors: Hsuanyeh Chang, Newton, MA (US); Zachary Michael Thomas, Pittsburgh, PA (US); Anping Liu, Acton, MA (US)

(21) Appl. No.: 16/349,596

(22) PCT Filed: Nov. 14, 2017
(86) PCT No.: PCT/US17/61643

§ 371 Date: Oct. 3, 2019

Related U.S. Application Data
(60) Provisional application No. 62/422,204, filed on Nov. 15, 2016.
(60) Provisional application No. 62/473,295, filed on Mar. 17, 2017.

(51) Int. Cl. G06K 9/00; G06F 3/044

(52) U.S. Cl. CPC G06K 9/0004; G06F 2203/04105; G06F 3/044

(57) ABSTRACT

The present disclosure provides an apparatus for optically capturing images using a display screen. The apparatus includes a sensor panel having a sensor substrate and an array of photosensitive pixels on an upper surface of the sensor substrate; a display panel disposed on the upper surface of the sensor substrate, the display panel having a display substrate, a plurality of display pixels on a first surface of the display substrate, and a black matrix on the first surface, wherein the black matrix includes a plurality of optical elements, each being located between neighboring ones of the display pixels, and wherein the sensor panel is in contact with a second surface of the display substrate opposing the first surface; and a cover sheet on the first surface of the display substrate. The black matrix includes a conductive material electrically coupled to a common electrode of the display panel.

### RELATED APPLICATION

This application relates to U.S. Provisional Application No. 62/422,204 (BD-005 PROV), filed Nov. 15, 2016, U.S. Provisional Application No. 62/473,295 (BD-005PROV2), filed Mar. 17, 2017, and PCT Application No. PCT/US17/61643 (BD-005PCT), filed on Nov. 14, 2017. The entire contents of all of the above applications are incorporated herein by reference for all purposes.

The present disclosure further relates to U.S. patent application Ser. No. 14/690,495 (BD-001 US), filed on Apr. 20, 2015 and issued as U.S. Pat. No. 9,122,349 on Sep. 1, 2015, which is a Continuation of International Application No. PCT/US15/021199 (BD-001 PCT), filed on Mar. 18, 2015, which claims priority to U.S. Provisional Application No. 62/025,772 (BD-001 PROV2), filed on Jul. 17, 2014 and U.S. Provisional Application No. 61/955,223 (BD-001 PROV1), filed on Mar. 19, 2014. The entire contents of all of the above applications are incorporated herein by reference for all purposes.

The present disclosure further relates to U.S. Provisional Application No. 62/236,125 (BD-002 PROV), filed on Oct. 1, 2015, the entire contents of which are incorporated herein by reference for all purposes.

The present disclosure further relates to U.S. Provisional Application No. 62/253,586 (BD-003 PROV), filed on Nov. 10, 2015, the entire contents of which are incorporated herein by reference for all purposes.

### TECHNICAL FIELD

The present disclosure relates to an apparatus and a method for optically capturing fingerprint or other images on a display screen. More particularly, the present disclosure relates to an apparatus and a method for optically capturing fingerprint or other images using the entire display screen.

### BACKGROUND

Flat panel displays have been used ubiquitously as a standard output device for various stationary or mobile electronic apparatuses, such as, personal computers, laptop computers, smart phones, smart watches, televisions, handheld video game devices, public information displays, and the like.

Recently, flat panel displays have been developed to include an image sensor panel (ISP) device disposed on a display panel device (e.g., liquid crystal display (LCD), organic light emitting diode (OLED) display, etc.) to optically capture fingerprints and other images (see, e.g., BD-001 US). An ISP includes a two dimensional (2D) array of photosensitive pixels distributed over the display area. The photosensitive pixels are small, occupying only a fraction of the total surface area, and positioned such that there is limited reduction in the performance of the display. The illuminating source light is provided by the display itself. A transparent protective sheet, such as a cover glass, is often placed on top of the ISP device to protect the photosensitive pixels. Control electronics use the ISP to capture images of the light reflected back on the ISP, typically from objects such as fingers, documents, and other objects touching or in close proximity to the protective sheet.

### SUMMARY

In one aspect, the present disclosure provides an apparatus for optically capturing images using a display screen, the apparatus comprising: a sensor panel having a sensor substrate and an array of photosensitive pixels on an upper surface of the sensor substrate; a display panel disposed on the upper surface of the sensor substrate, the display panel having a display substrate, a plurality of display pixels on a first surface of the display substrate, and a black matrix on the first surface, wherein the black matrix includes a plurality of optical elements, each being located between neighboring ones of the display pixels, and wherein the sensor panel is in contact with a second surface of the display substrate opposing the first surface; and a cover sheet on the first surface of the display substrate; wherein the black matrix comprises an electrically conductive material and is electrically coupled to a common electrode of the display panel.

In one embodiment, the optical elements comprise a pinhole.

In one embodiment, the display substrate has a first thickness defined by a separation distance between the first surface and the second surface, the cover sheet has a second thickness, and the pinhole has a lateral dimension.

In one embodiment, the first thickness, the second thickness, and the lateral dimension are configured such that an image is formed on the upper surface of the sensor substrate, the image corresponding to at least a portion of an object placed on an outer surface of the cover sheet.

In one embodiment, side surfaces of the sensor panel, the display panel, and the cover sheet are covered with an opaque material so as to prevent light from entering into the sensor panel from the side surfaces.

In one embodiment, the cover sheet and the display substrate comprises a optically transparent material.

In one embodiment, the cover sheet and the display substrate comprise one of a plastic material and a glass material.

In one embodiment, the photosensitive pixels are configured to have a sensor resolution that is greater than or equal to 500 ppi.

In one embodiment, the display pixels comprise a self-emitting optical element.

In one embodiment, the optical elements comprise a microlens.

In another aspect, the present disclosure provides a method for optically capturing images using the apparatus, as described above. The method comprises: placing the object on an outer surface of the cover sheet; driving regions of the photosensitive pixels to capture images formed on the upper surface of the sensor panel through the optical elements; and combining the captured images to form a full image representing an entire outer surface of protective sheet.

In one embodiment, each of the regions comprises an array of photosensitive pixels.

In accordance with another aspect, the present disclosure provides an apparatus for optically capturing images using a display screen, the apparatus comprising: a sensor panel having a sensor substrate and an array of photosensitive pixels on an upper surface of the sensor substrate; a display panel disposed on the upper surface of the sensor substrate, the display panel having a display substrate, a plurality of display pixels on a first surface of the display substrate, and a common electrode electrically connected to the display pixels; a black matrix layer on the first surface of the display panel, the black matrix layer having a plurality of apertures, each aligned with a respective one of the display pixels to allow light from the display pixels to be emitted therethrough, the black matrix layer further including a plurality of optical elements, each of the optical elements being located between neighboring ones of the apertures; and a cover sheet on the black matrix layer; wherein the black matrix layer comprises an electrically conductive material and is electrically coupled to the common electrode of the display panel.

In one embodiment, the optical elements comprise a pinhole or a microlens.

In one embodiment, the display pixels comprise a self-emitting optical element.

In one embodiment, the self-emitting optical element is an organic light emitting diode (OLED) pixel.

In accordance with still another aspect, the present disclosure provides a method for capturing a fingerprint image using a mobile device having a display screen with an image sensor panel and a force touch panel, the method comprising: detecting a force exerted by a finger on a first region of the display screen using the force touch panel; and when the force is greater than a predetermined threshold value, illuminating the finger by emitting light from at least the first region of the display screen, and capturing an image of the finger using the image sensor panel.

In one embodiment, prior to detecting the force exerted by the finger, the method further comprises detecting presence of the finger on the display screen using a capacitive touch panel of the mobile device.

In one embodiment, detecting the force comprises measuring a capacitance change of a capacitance sensor in the force touch panel, wherein the capacitance change increases as the exerted force increases.

### BRIEF DESCRIPTION OF THE DRAWINGS

FIG. 1 illustrates a sectional view of an apparatus for optically capturing a fingerprint or other images, in accordance with an embodiment of the present disclosure.

FIG. 2 illustrates a plane view of an exemplary image sensor panel of the apparatus as shown in FIG. 1.

FIG. 3 illustrates a sectional view of a photosensitive pixel of the image sensor panel as shown in FIG. 2.

FIGS. 4A through 4C illustrate a top view of exemplary display panels of the apparatus as shown in FIG. 1.

FIG. 5 illustrates a top view of another exemplary display panel of the apparatus as shown in FIG. 1.

FIG. 6 illustrates exemplary number of photosensitive pixels that each pinhole on a display panel can correspond.

FIG. 7 schematically illustrates the correspondence relation of pinhole images with respect to regions of photosensitive pixels on a sensor panel.

FIG. 8 illustrates a sectional view of an apparatus for optically capturing a fingerprint or other images, in accordance with an embodiment of the present disclosure.

FIG. 9 illustrates a sectional view of an apparatus for optically capturing a fingerprint or other images, in accordance with an embodiment of the present disclosure.

FIG. 10 illustrates a mechanism for triggering fingerprint sensing functionality by an exemplary pressure pattern, in accordance with an embodiment of the present disclosure.

FIG. 11 illustrates a schematic circuit of a lighting emitting pixel of an active matrix organic light emitting diode (AMOLED), in accordance with an embodiment of the present disclosure.

FIG. 12 illustrates a sectional view of the light emitting pixel of FIG. 11.

### DETAILED DESCRIPTION

The inventors have recognized and appreciated that the effective resolution achieved by an ISP can be reduced due to blurring resulting from the distance between the imaged object and the 2D photosensitive pixel array. The inventors have further recognized and appreciated that the thickness of the transparent protective sheet is, under many circumstances, the largest contributor to this distance. If the protective sheet has a thickness much greater than the pixel pitch or lateral dimension (e.g., length or width) of individual photosensitive pixels, the optical resolution of the ISP device may be adversely affected, thereby causing the detected optical images to become blurry. For example, for an ISP device having a sensor resolution of 500 Pixels-Per-Inch (PPI), each photosensitive pixel has a pixel pitch of 2.0 thou (about 50 μm). If the protective sheet disposed on the ISP has a thickness of greater than 500 μm, or any other thickness much greater than the pixel pitch, the ISP may not be able to resolve images to 500 PPI; that is, the detected optical image may be blurry.

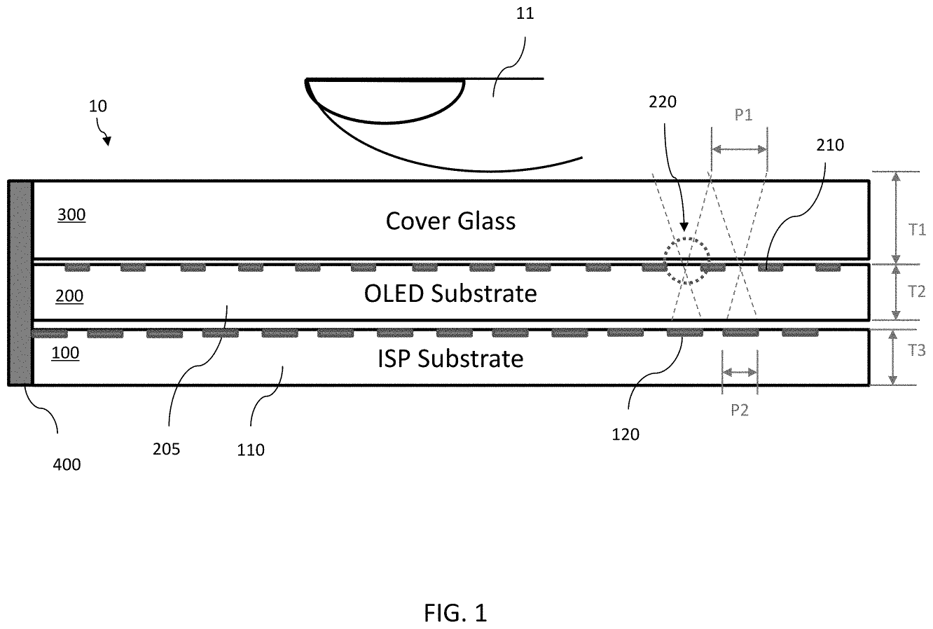

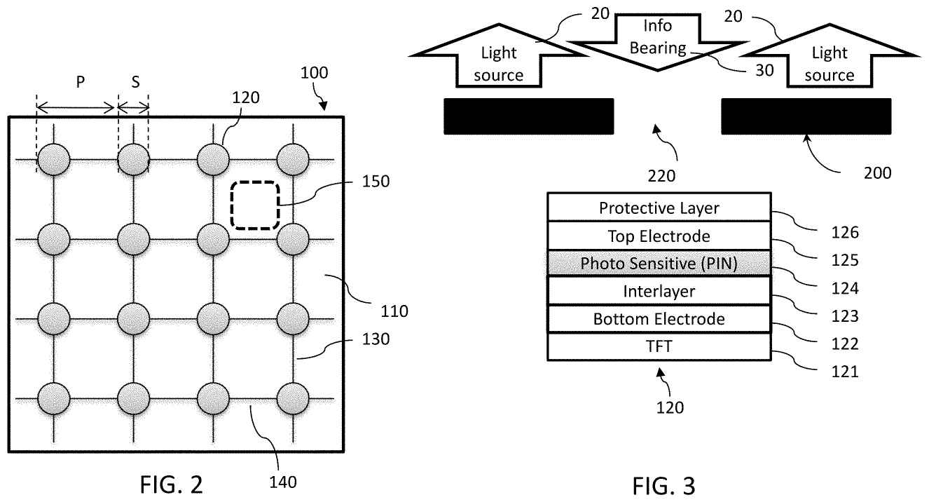

In view of the above, the inventors have developed an apparatus and a method for optically capturing fingerprint or other images on a display screen with improved optical performance. FIG. 1 illustrates a sectional view of an apparatus 10 for optically capturing a fingerprint or other optical images, in accordance with an embodiment of the present disclosure. FIG. 2 illustrates a plane view of apparatus 10.

As shown in FIG. 1, apparatus 10 includes an image sensor panel (ISP) 100, a display panel 200 disposed on ISP 100, and a protective sheet (or cover glass) 300 disposed on display panel 200. Display panel 200, which output light, is shown as an OLED (organic light emitting diode) display, but any suitable display panel may be used. Display panel 200 may be disposed in contact with ISP 100, with a lower surface of display panel 200 being glued on ISP 100 using an appropriate adhesive material. Protective sheet 300 may be disposed in contact with an upper surface of display panel 200, with or without any adhesive material. In one embodiment, display panel 200 is glued on ISP 100 using an optically transparent adhesive, and cover glass 300 is glued on display panel 200 using an optically transparent adhesive. In one embodiment, a light block layer 400 is formed throughout peripheral surfaces of ISP 100, display panel 200, and protective sheet 300, so as to prevent environmental light from entering into apparatus 10 through side surfaces thereof.

Referring to FIG. 1, ISP 100 comprises a substrate 110 having a thickness of T3 and an array of photosensitive pixels 120 formed on an upper surface of substrate 100. Photosensitive pixels 120 may be physically separated from each other to reduce or eliminate the interference and/or crosstalk among photosensitive pixels 120. In one embodiment, ISP 100 may have a resolution of about 500 pixels per pixel (PPI), which translates to a pixel pitch of about 50 μm (micron), with each photosensitive pixel 120 having a lateral dimension (length or width) of P2 (e.g., about 10-40 μm). In other words, photosensitive pixels 120 may have a lateral dimension that is about 20% to 80% of their pixel pitch. More details about ISP 100 will be discussed below.

Referring again to FIG. 1, display panel 200 comprises a transparent substrate 205 having a thickness T2, an array of light emitting pixels 210 disposed on an upper surface of transparent substrate 205, and a plurality of optical elements (e.g., pinholes, microlenses, etc.) 220 formed in a black matrix disposed on the upper surface of transparent substrate 205 and between neighboring light emitting pixels 210. Light emitting pixels 210 may be organic light emitting diodes (OLED), light emitting quantum dots (QD), or any other suitable light emitting (or self-emitting) elements. In one embodiment, thickness T2 of transparent substrate 205 is less than or equal to thickness T1 of cover plate 300. Thickness T2 of transparent substrate 205 may be about 100 μm to about 2,000 μm.

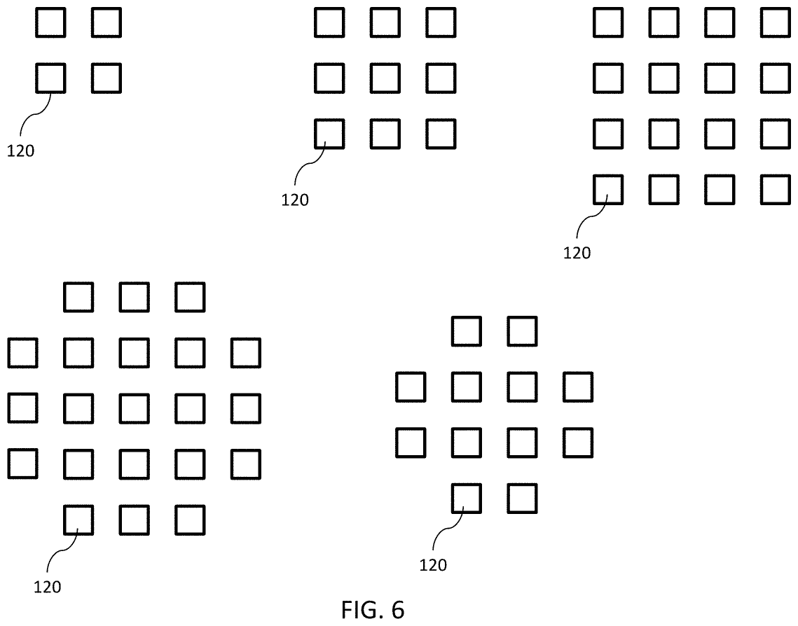

For example, thicknesses T1 and T2 can be configured to be substantially the same. In this case, ISP 100 can capture an optical image of an object 11 placed on the upper surface of protective sheet 300 with substantially the same optical resolution as the pixel density or resolution of ISP 100. In certain embodiments, each pinhole 220 on display panel 200 can be configured to correspond to multiple photosensitive pixels 120 on ISP 100. For example, one pinhole 220 can correspond to 4, 9, 12, 16, 21, 24, 25, or more photosensitive pixels 120 (as shown in FIG. 6).

In general, apparatus 10 operates as follows. In response to a finger 11 or another object being placed in contact with an upper surface of protective sheet 300, a control circuitry (not shown) is used to generate a control signal causing display pixels 210 of display panel 200 to emit light and illuminate finger 11. Through the use of optical elements 220 (a.k.a., light focusing elements 220), the light reflected from finger 11 is detected by photosensitive pixels 120 of ISP 100, thereby forming a fingerprint image. In essence, each light focusing element 220 restricts the light captured by a respective photosensitive pixel 120 to a narrowed region above the photosensitive pixel 120. By restricting the captured light to a narrowed region adjacent photosensitive pixels 120, one may capture light reflected from different features of finger 11 or any other objects.

FIG. 2 illustrates a plane view of an exemplary image sensor panel (ISP) 100 of apparatus 10 as shown in FIG. 1. ISP 100 includes a transparent substrate 110, an array of photosensitive pixels 120, and a plurality of column conductive lines (columns) 130 and row conductive lines (rows) 140 electrically coupled with photosensitive pixels 120. In certain embodiments, ISP 100 may also include a plurality of capacitive touch sensor pixels (not shown), such as that disclosed in BD-002 PROV. Photosensitive pixels 120 may be formed proximate intersections of columns 130 and rows 140. In certain embodiments, photosensitive pixels 120 can be arranged on a first region of substrate 110 to form a square lattice structure, a rectangular lattice structure, a triangular lattice structure, a hexagonal lattice structure, and the like. Each of photosensitive pixels 120 can be configured to have, for example, a circular shape, an oval shape, a square shape, a rectangular shape having rounded corners, or any other suitable shapes. In one embodiment, the first region of substrate 110 is rendered optically opaque or non-transparent due to the presence of photosensitive pixels 120. In one embodiment, ISP 100 is devoid of light emitting elements and optically transparent at non-photosensitive pixel regions (i.e., other than the first region).

In the embodiment of a square lattice structure (upright or diagonal), each photosensitive pixel may have a photosensitive pixel size S (e.g., a width or diameter, depending on the pixel shape, of about 10-100 μm) and two neighboring photosensitive pixels may be separated by a pixel pitch P. Pixel pitch P may be about 1.1 to 5 times of pixel size S (i.e., P is at least 10% greater than S). For example, pixel size S may be 20 μm, while pixel separation may be 25 μm (P=1.25 S), 30 μm (P=1.5 S), 40 μm (P=2 S), or 50 μm (P=2.5 S). Photosensitive pixels 120 are separated so as to prevent crosstalk among neighboring photosensitive pixels and to leave regions 150 (i.e., the non-sensor pixel regions) that may be made of a material that is transparent, opaque or in between.

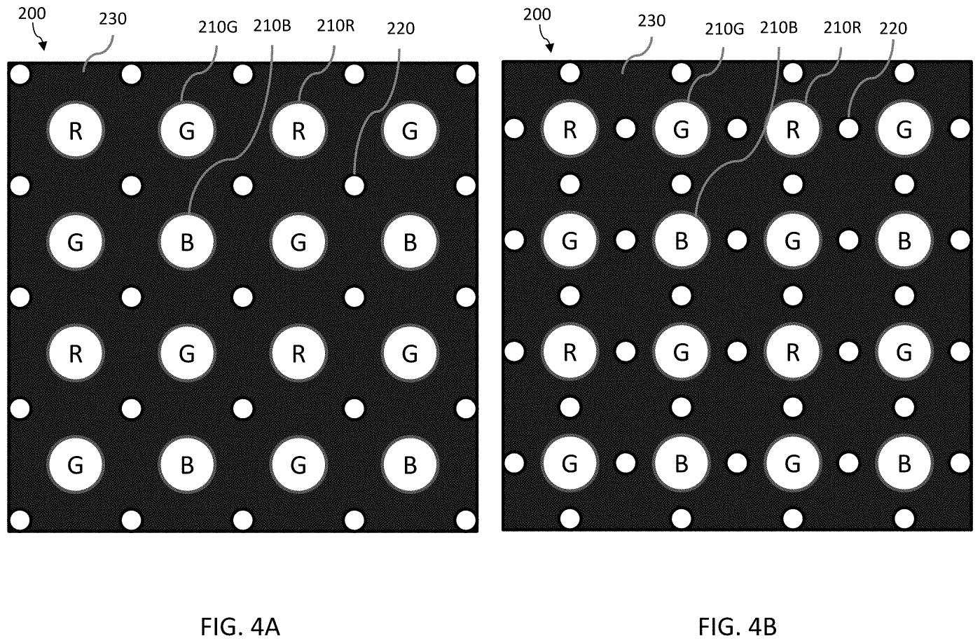

FIG. 3 illustrates a sectional view of a photosensitive pixel 120 of ISP 100 as shown in FIG. 2. Referring to FIG. 3, photosensitive pixel 120 may be formed on a control element 121 (e.g., one or more TFTs) and include a bottom electrode 122 on control element 121, an interlayer 123 on bottom electrode 122, a photosensitive layer 124 on interlayer 123, a top electrode 125 on photosensitive layer 124, and a protective layer 126 (optional) on top electrode 125. In this embodiment, top electrode 125 serves as a common electrode which is electrically connected to the ground when photosensitive pixel 120 is configured to detect optical signals. Two terminals of control element 121 are electrically coupled to a column and a row, respectively.

As shown in FIG. 3, ISP 100 is placed behind or beneath display panel 200 proximate the non-emitting surface of display panel 200. Photosensitive pixels 120 are aligned with a respective pinhole formed on display panel 200. Light emitting pixels of display panel 200 provides light source 20 to an object placed on protective sheet 300 (see, FIG. 1) over display panel 200. The information bearing light 30 reflected from the object 10 carries information of the object can be detected by photosensitive pixels 120 through pinhole 220. Pinhole 220 is provided primarily to limit the field of view of photosensitive pixels 120 to within the desired viewing angle, such that reflected light from undesired regions is not “seen” or detected by photosensitive pixel 120. It is appreciated that other micro optical elements (e.g., microlens, micro optical collimator, and the like) may be used in place of pinhole 220 to achieve substantially the same purpose.

In one embodiment, photosensitive layer 124 may comprise semiconductor materials, e.g., amorphous silicon (a-Si), low temperature polysilicon (LTPS), metal oxide (ZnO, IGZO, etc.), and the like, which form a PIN structure. Alternatively, photosensitive layer 124 may comprise organic photosensitive materials, carbon nanotube or fullerene based photosensitive materials, or the like. Interlayer 123 is optional and may comprise PEDOT:PSS. Protective layer 126 is optional and may comprise a transparent laminating material.

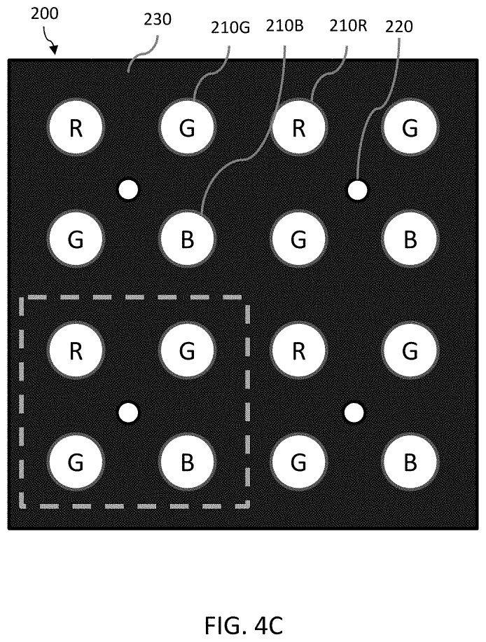

Referring to FIG. 4A, there is illustrated a top view of an exemplary display panel 200 of apparatus 10 in FIG. 1. As shown in FIG. 4A, display panel 200 comprises an array of display pixels 210 arranged as a diamond pixel scheme (or an RGBG matrix), a plurality of pinholes 220, and a black matrix 230 formed between display pixels 210 and pinholes 220. Black matrix 230 may also be formed under pixels 210 to reduce the amount of light that is received by photosensitive pixels 120 without reflecting from the target object 11. In this embodiment, each RGBG color pixel comprises one red pixel 210R that emits red color light, one blue pixel 210B that emits blue color light, and two green pixels 210G that emit green color light. Each of display pixels 210R, 210G, and 210B may comprise a self-emitting element, such as, an organic light emitting diode (OLED), a quantum dot (QD), and the like. The self-emitting elements emit light source having an intensity corresponding to a voltage or current value of an electrical driving signal. Unlike a liquid crystal display (LCD) pixel, which requires backlight, in this embodiment, display pixels 210 are self-emitting and do not require an external light source. In one embodiment, black matrix 230 comprises a layer of, for example, resin, silver, or any other materials that are optically opaque. It is appreciated that black matrix 230 is electrically insulated from display pixels 201.

In one embodiment, one pinhole 220 is formed in black matrix 230 per one RGBG color pixel. Specifically, as shown in FIG. 4A, one pinhole 220 is formed for each four neighboring display pixels 210R, 210B, and 210G that may constitute an RGBG color pixel. That is, suppose there is an imaginary straight line that connects two nearest neighboring green pixels 210G, in this embodiment, one pinhole 220 is formed along the imaginary line and is substantially equally spaced from the two neighboring green pixels 210G. Depending on the sensor resolution and the thickness of black matrix 230, pinholes 220 may have a lateral dimension of about 1 μm to 50 μm.

Referring to FIG. 4B, there is illustrated a top view of another exemplary display panel 200 of apparatus 10 in FIG. 1. Display panel 200 shown in FIG. 4B is substantially the same as that shown in FIG. 4A, except that a different arrangement of pinholes 220 is formed on black matrix 230. In this embodiment, one pinhole 220 is formed between two nearest neighboring display pixels 210 regardless of their colors. That is, one pinhole 220 is formed between the nearest neighboring green pixel 210G and blue pixel 210B, and one pinhole 220 is formed between the nearest neighboring green pixel 210G and red pixel 210R. In an alternative embodiment, one pinhole 220 may be additionally formed between the nearest neighboring blue pixel 210B and red pixel 210R.

Referring to FIG. 4C, there is illustrated a top view of yet another exemplary display panel 200 of apparatus 10 in FIG. 1. Display panel 200 shown in FIG. 4C is substantially the same as that shown in FIGS. 4A and 4B, except that a different arrangement of pinholes 220 is formed on black matrix 230. As shown in FIG. 4C, much fewer number of pinholes 220 is formed on display panel 200 than that of FIGS. 4A and 4B. In this embodiment, only one pinhole 220 is formed at the center of each RGBG color pixel.

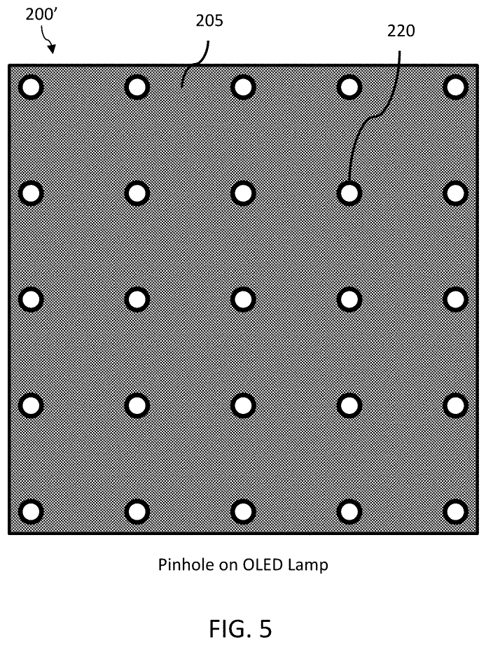

FIG. 5 illustrates a top view of another exemplary display panel 200′ of apparatus 10 as shown in FIG. 1. In contrast to display panel 200 shown in FIGS. 4A through 4C, in this embodiment, display panel 200′ is a flat panel light source, such as an OLED lamp, having effectively only one display pixel. A layer of light emitting diode can be formed on substrate 205 so as to make the entire upper surface of display panel 200′ to emit light in response to an electrical driving signal applied thereto. It is appreciated that a light block layer can be formed on substrate 205 prior to forming the layer of light emitting diode on the light block layer. Such light block layer can reduce light of display panel 200′ from leaking into ISP 100 without having reflected off the object to be imaged. Further, an array of pinholes 220 can be formed on the display panel 200′ such that reflected light from object 11 (e.g., finger) placed on cover plate 300 can be captured by ISP 100 on which display panel 200′ is disposed.

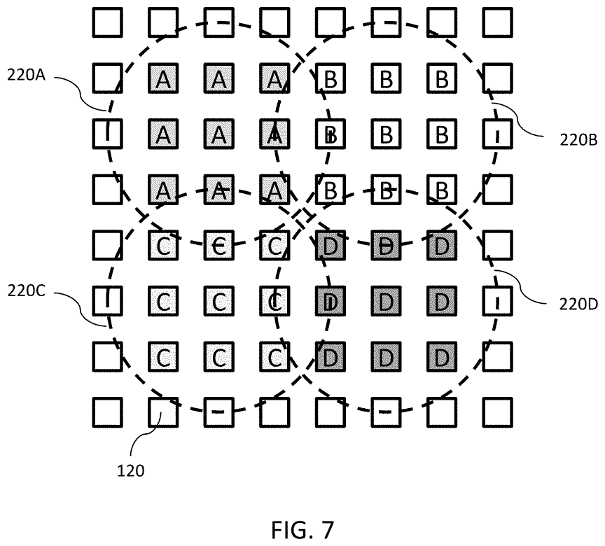

FIG. 7 schematically illustrates the correspondence relation of pinhole images 220A, 220B, 220C, and 220D with respect to regions A, B, C, and D of photosensitive pixels 120 on ISP 100. Although four regions A, B, C, and D are shown and described herein, it is appreciated that any suitable number of regions can be divided on ISP 100.

Referring to both FIGS. 1 and 7, a first pinhole 220 on display panel 200 can form a first image 220A for a first portion of object 11 (e.g., finger) placed on protective sheet 300. As such, region A of photosensitive pixels 120 captures first image 220A for the first portion of object 11. Likewise, a second (third, fourth) pinhole 220 on display panel 200 can form a second (third, fourth) image 220B (220C, 220D) for a second (third, fourth) portion of object 11, and region B (C, D) of photosensitive pixels 120 captures second (third, fourth) image 220B (220C, 220D) for the second (third, fourth) portion of object 11.

In this embodiment, each of first, second, third, and fourth images 220A, 220B, 220C, and 220D may represent a different portion of object 11, and such portions may overlap at edges thereof. As such, a driving circuit (not shown) may be configured to sequentially drive display pixels 210 neighboring pinholes 220 to emit light source. In addition, a readout circuit (not shown) may be configured in conjunction with the driving circuit (not shown) to drive ISP 100 by the regions (instead of by the pixels), so as to sequentially capture images respectively from regions A, B, C, and D of photosensitive pixel 120, each region corresponding to a pinhole.

In certain embodiments, images captured by region A, for example, may overlap with images captured by regions B and/or C. Accordingly, images captured by neighboring regions of photosensitive pixels 120 may be stitched together using a computer software program to form a larger, full image. Such full image may represent an image for the entire upper surface of protective sheet 300.

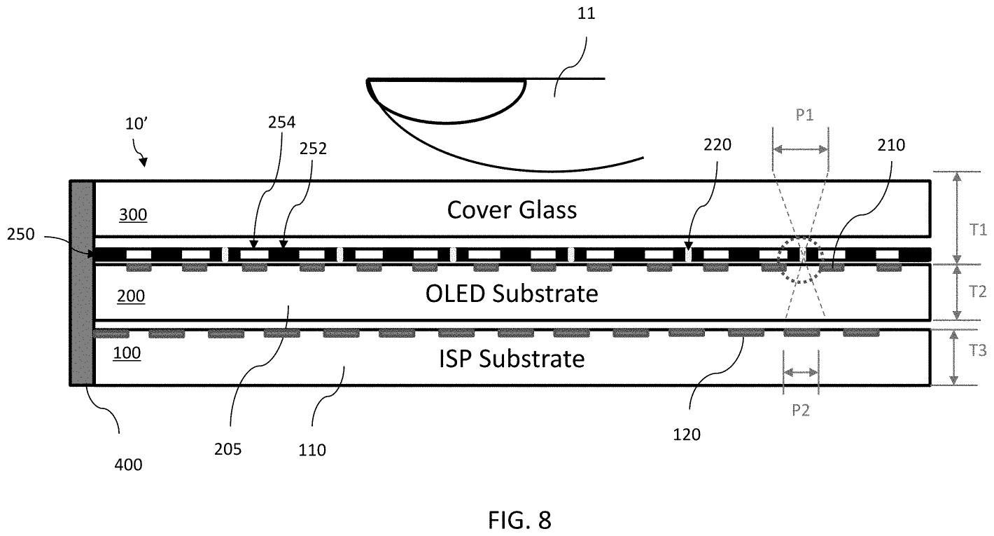

FIG. 8 illustrates a sectional view of an apparatus 10′ for optically capturing a fingerprint or other images of an object, in accordance with another embodiment of the present disclosure. Apparatus 10′ in FIG. 8 is substantially the same as apparatus 10 in FIG. 1, except that a separate black matrix layer 250 is used in place of black matrix 230 on display panel 200 or substrate 205. As shown in FIG. 8, black matrix layer 250 is glued or otherwise disposed on an upper surface of display panel 200. Protective sheet 300 may then be disposed in contact with an upper surface of black matrix layer 250. In one embodiment, black matrix layer 250 can be made of a resin, plastic, or any other suitable material. Black matrix layer 250 may have a thickness of about 10 to 100 μm.

In one embodiment, black matrix layer 250 comprises a region 252 and region 254. In one embodiment, region 254 comprises a plurality of apertures that are aligned with the underlying light emitting pixels 210. Region 254 may be optically transparent such that the display quality of display panel 200 is substantially unaffected. In one embodiment, the apertures can be formed in black matrix layer 250 by, for example, laser boring or other suitable puncturing, etching, and photolithography methods.

As shown in FIG. 8, black matrix layer 250 further comprises a plurality of optical elements 220 (such as pinholes and microlenses) in region 252. Such optical elements 220 may be optically transparent at desired wavelengths (e.g., for visible or infrared light). In the case of pinholes, optical elements 220 can be formed concurrently with the apertures of region 254 by, for example, laser boring or other suitable puncturing, etching, and photolithography methods. In various embodiments, optical elements 220 (or pinholes) on black matrix layer 250 may form a two-dimensional array as shown in FIG. 4A, 4B, or 4C, as described above. In one embodiment, black matrix layer 250 may be made of an optically opaque material, such as metal (e.g., silver) or metal oxide (e.g., silver oxide).

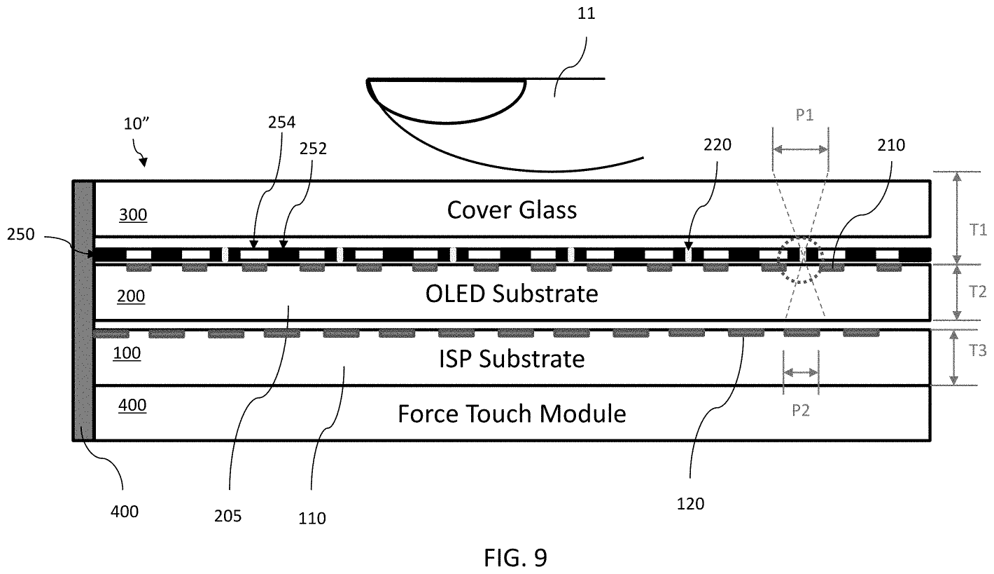

FIG. 9 illustrates a sectional view of an apparatus 10″ for optically capturing a fingerprint or other images of an object (e.g., fingerprint of a finger) in accordance with another embodiment of the present disclosure. Apparatus 10″ in FIG. 9 is substantially the same as apparatus 10′ in FIG. 8, except that apparatus 10″ in FIG. 9 additionally includes a force touch panel 400 disposed behind ISP 100. In one embodiment, force touch panel 400 uses a capacitance sensor (which may include one or more capacitive sensing pixels) to measure a magnitude of a pressure or force exerted by the object on the upper surface of apparatus 10″ based on capacitance change of the capacitance sensor. In one embodiment, the capacitance change increases as the pressure or force exerted on apparatus 10″ increases.

Referring to FIG. 9, in one embodiment, the present disclosure provides a method for capturing a fingerprint image using a mobile device having a display screen 10″ with an image sensor panel 100 and a force touch panel 400. In one embodiment, apparatus 10″ may additional include a capacitive touch panel (not shown) between cover glass 300 and OLED 200. A user may set up the security feature of his or her mobile device including apparatus 10″ such that the mobile device can be unlocked using his/her fingerprint(s). Because both force touch panel 400 and the capacitive touch panel (not shown) measures capacitance changes due to either pressure or contact of a human finger, in one embodiment, these two panels may be integrated into a single device using one or more properly designed readout integrated circuit.

Initially, a mobile device may be idle or in standby mode. To wake up the mobile device, the user may press his or her finger 11 on apparatus 10″ (or display screen 10″) to exert a force on an upper surface of apparatus 10″. In one embodiment, the capacitive touch panel (not shown) may detect the presence/contact of finger 11 on apparatus 10″ and turn on force touch panel 400 in response to the presence/contact of finger 11. When the force exerted by finger 11 exceeds a predetermined threshold value, OLED 200 is turned on to emit light within at least a region of apparatus 10″ corresponding to and slightly greater than the contact region of finger 11, thereby illuminating finger 11. ISP 100 is also turned on to capture light emitted from OLED 200 and reflected from finger 11, thereby capturing a fingerprint image.

In certain embodiments, a user may accidentally turned on the fingerprint sensing functionality by unintentionally pressed display screen 10″ too hard. Accordingly, the user may set up their mobile device to trigger fingerprint sensing only after a certain pattern of pressure is applied to display screen 10″.

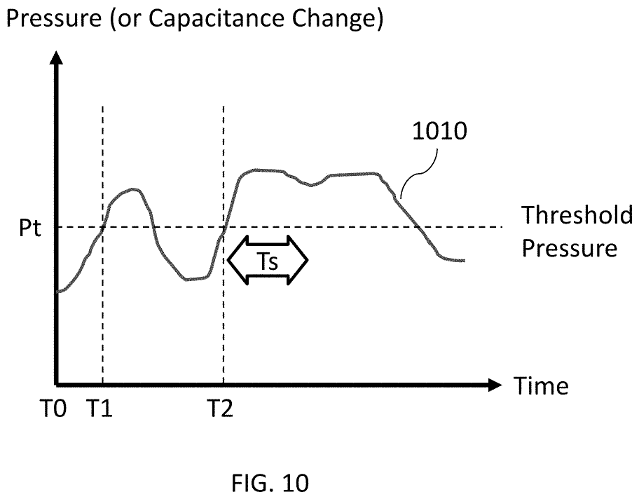

FIG. 10 illustrates a mechanism for triggering fingerprint sensing functionality by an exemplary pressure pattern 1010, in accordance with an embodiment of the present disclosure. In one embodiment, as shown in FIG. 9, finger 11 contacts display screen 10″ at time point T0 and exerts a pressure thereon in accordance with pressure pattern 1010. In this embodiment, pressure pattern 1010 resembles what is “double-click-and-hold” of a computer mouse button.

As shown in FIG. 10, pressure pattern 1010 begins from a value less than a threshold pressure Pt. Subsequently, threshold pressure Pt increases and exceeds threshold pressure Pt for the first time at time point T1. At this time, the mobile device does not yet respond to the finger pressure. After time point T1, pressure pattern 1010 decreases to a value less than threshold pressure Pt and then increases again to greater than threshold pressure Pt at time point T2. At this time, the fingerprint sensing functionality is triggered, and a fingerprint image or snapshot is optically captured. Normally, pressure pattern 1010 would hold at substantially the same pressure level when fingerprint snapshot is taken during snapshot time Ts.

As discussed above, the fingerprint image can be captured by (1) turning on OLED 200 to emit light within at least a region of display screen 10″ corresponding to and slightly greater than the contact region of finger 11, thereby illuminating finger 11, and (2) turning on ISP 100 to capture light emitted from OLED 200 and reflected from finger 11, thereby capturing a fingerprint image or snapshot.

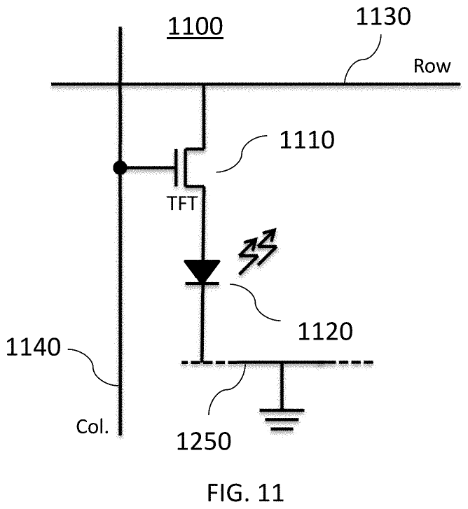

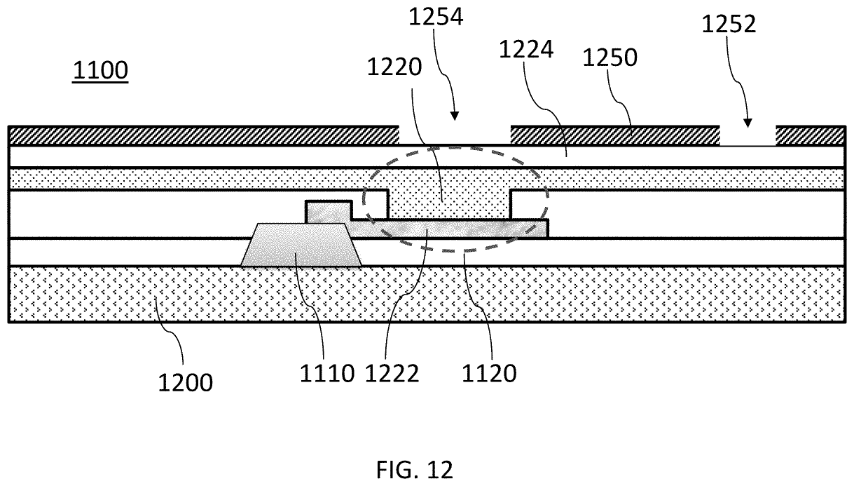

FIG. 11 illustrates a schematic circuit of a light emitting pixel 1100 of an active matrix organic light emitting diode (AMOLED), in accordance with an embodiment of the present disclosure. FIG. 12 illustrates a sectional view of light emitting pixel 1100 of FIG. 11. It is appreciated that a typical AMOLED includes a plurality of light emitting pixels 1100 arranged on a two-dimensional surface. Each of the light emitting pixels 1100 is arranged proximate a crossing of row and column electrodes 1130, 1140, and driven by electrical signals transmitted thereto through column and row electrodes 1130, 1140.

As shown in FIG. 11, light emitting pixel 1100 includes a light emitting diode (OLED) 1120 made by, for example, an organic material and electrically controlled by a thin film transistor (TFT) 1110 via row electrode 1130 and column electrode 1140. As shown in FIG. 11, in one embodiment, a cathode terminal of OLED 1120 is connected to the ground (or a common voltage) through a common electrode 1250. In one embodiment, common electrode 1250 comprises a transparent metal, e.g., ITO. In one embodiment, common electrode 1250 may additionally or alternatively include a pinhole layer or black matrix layer 250 as shown in FIG. 8. Black matrix layer 250 may be made of a metal material (e.g., silver), a metal oxide material (e.g., silver oxide), or other electrically conductive and optically opaque material. That is, black matrix layer 250 of FIG. 8 can also serve as a common electrode for the AMOLED while providing a focusing mechanism for fingerprint sensing.

Referring to both FIGS. 11 and 12, light emitting pixel 1100 comprises TFT 1110 disposed on a transparent substrate 1200 and OLED 1120 electrically coupled to TFT 1110. OLED 1120 comprises an anode 1222 electrically coupled to TFT 1110, a cathode 1224 electrically coupled to the ground or common electrode, and an organic light emitting material layer 1220 between anode 1222 and cathode 1224. In one embodiment, cathode 1224 can be made of an optical transparent conductor, such as ITO. Moreover, a black matrix layer 1250 can be formed on cathode 1224 to serve as at least a part of the common electrode, thereby connecting cathodes 1224 of all light emitting pixels to the ground. Black matrix layer 1250 may be made of an electrically conductive and optically opaque material, and includes a plurality of pinholes 1252 and a plurality of apertures 1254. Apertures 1254 allows light emitted from OLED 1120 to emit therethrough, while pineholes 1252 are provided to capture fingerprint or other images as discussed above with respect to FIG. 8.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical values appeared in this specification are deemed modified by a term of degree thereby reflecting their intrinsic uncertainty.

Although various embodiments of the present disclosure have been described in detail herein, one of ordinary skill in the art would readily appreciate modifications and other embodiments without departing from the spirit and scope of the present disclosure.

What is claimed is:

1. An apparatus for optically capturing images using a display screen, the apparatus comprising:
a sensor panel having a sensor substrate and an array of photosensitive pixels on an upper surface of the sensor substrate;
a display panel disposed on the upper surface of the sensor substrate, the display panel having a display substrate, a plurality of display pixels on a first surface of the display substrate, and a black matrix on the first surface, wherein the black matrix includes a plurality of optical elements, each being located between neighboring ones of the display pixels, and wherein the sensor panel is in contact with a second surface of the display substrate opposing the first surface; and
a cover sheet on the first surface of the display substrate;
wherein the black matrix comprises an electrically conductive material and is electrically coupled to a common electrode of the display panel.

2. The apparatus of claim 1, wherein the optical elements comprise a pinhole.

3. The apparatus of claim 2, wherein the display substrate has a first thickness defined by a separation distance between the first surface and the second surface, the cover sheet has a second thickness, and the pinhole has a lateral dimension.

4. The apparatus of claim 3, wherein the first thickness, the second thickness, and the lateral dimension are configured such that an image is formed on the upper surface of the sensor substrate, the image corresponding to at least a portion of an object placed on an outer surface of the cover sheet.

5. The apparatus of claim 1, wherein side surfaces of the sensor panel, the display panel, and the cover sheet are covered with an opaque material so as to prevent light from entering into the sensor panel from the side surfaces.

6. The apparatus of claim 1, wherein the cover sheet and the display substrate comprises a optically transparent material.

7. The apparatus of claim 1, wherein the cover sheet and the display substrate comprise one of a plastic material and a glass material.

8. The apparatus of claim 1, wherein the photosensitive pixels are configured to have a sensor resolution that is greater than or equal to 500 ppi.

9. The apparatus of claim 1, wherein the display pixels comprise a self-emitting optical element.

10. The apparatus of 1, wherein the optical elements comprise a microlens.

11. A method for optically capturing images using the apparatus of claim 1, the method comprising:
placing the object on an outer surface of the cover sheet;
driving regions of the photosensitive pixels to capture images formed on the upper surface of the sensor panel through the optical elements; and
combining the captured images to form a full image representing an entire outer surface of protective sheet.

12. The method of claim 11, wherein each of the regions comprises an array of photosensitive pixels.

13. An apparatus for optically capturing images using a display screen, the apparatus comprising:
a sensor panel having a sensor substrate and an array of photosensitive pixels on an upper surface of the sensor substrate;
a display panel disposed on the upper surface of the sensor substrate, the display panel having a display substrate, a plurality of display pixels on a first surface of the display substrate, and a common electrode electrically connected to the display pixels;
a black matrix layer on the first surface of the display panel, the black matrix layer having a plurality of apertures, each aligned with a respective one of the display pixels to allow light from the display pixels to be emitted therethrough, the black matrix layer further including a plurality of optical elements, each of the optical elements being located between neighboring ones of the apertures; and
a cover sheet on the black matrix layer;
wherein the black matrix layer comprises an electrically conductive material and is electrically coupled to the common electrode of the display panel.

14. The apparatus of claim 13, wherein the optical elements comprise a pinhole.

15. The apparatus of claim 13, wherein the optical elements comprise a microlens.

16. The apparatus of claim 13, wherein the display pixels comprise a self-emitting optical element.

17. The apparatus of claim 16, wherein the self-emitting optical element is an organic light emitting diode (OLED) pixel.

18. A method for capturing a fingerprint image using a mobile device having a display screen with an image sensor panel and a force touch panel, the method comprising:
detecting a force exerted by a finger on a first region of the display screen using the force touch panel; and
when the force is greater than a predetermined threshold value, illuminating the finger by emitting light from at least the first region of the display screen, and capturing an image of the finger using the image sensor panel.

19. The method of claim 18, prior to detecting the force exerted by the finger, further comprising detecting presence of the finger on the display screen using a capacitive touch panel of the mobile device.

20. The method of claim 18, wherein detecting the force comprises measuring a capacitance change of a capacitance sensor in the force touch panel, wherein the capacitance change increases as the exerted force increases.
